(19) United States
(12) Patent Application Publication
(10) Pub. No.: US 2014/0184616 A1
(43) Pub. Date: Jul. 3, 2014

(54) SYSTEM, METHOD, AND COMPUTER PROGRAM PRODUCT FOR IDENTIFYING A FAULTY PROCESSING UNIT

(71) Applicant: NVIDIA CORPORATION, Santa Clara, CA (US)

(72) Inventors: Apoorv Gupta, Santa Clara, CA (US); David William Crowe, San Jose, CA (US); Carl William Davies, Columbus (CA)

(73) Assignee: NVIDIA CORPORATION, Santa Clara, CA (US)

(21) Appl. No.: 13/730,596

(22) Filed: Dec. 28, 2012

(51) Int. Cl. G06F 11/27

(52) U.S. Cl. CPC G06F 11/27
USPC 345/505

(57) ABSTRACT

A system, process, and computer program product are provided for identifying a faulty processing unit. A shader program that configures a plurality of processing units to generate data is executed and the data is compared with verification data to produce a test result. The test result is examined to identify a faulty processing unit of the plurality of processing units, where a unique identifier corresponding to each processing unit is encoded into the data generated by the respective processing unit.

### FIELD OF THE INVENTION

The present invention relates to computing, and more particularly to the identification of a faulty processing unit.

### BACKGROUND

Complex integrated circuits are tested by applying test patterns to identify faulty chips that do not function properly. In some cases, only one of the sub-units within an integrated circuit is faulty and the integrated circuit can operate at a lower performance level with the one sub-unit disabled. However, identifying the particular sub-unit that may be responsible for the failure seen at the integrated circuit level is difficult at best and time consuming because functionality of the individual sub-unit needs to be tested serially.

Thus, there is a need for addressing this issue and/or other issues associated with the prior art.

### SUMMARY

A system, method, and computer program product are provided for identifying a faulty processing unit. A shader program that configures a plurality of processing units to generate data is executed and the data is compared with verification data to produce a test result. The test result is examined to identify a faulty processing unit of the plurality of processing units, where a unique identifier corresponding to each processing unit is encoded into the data generated by the respective processing unit.

### BRIEF DESCRIPTION OF THE DRAWINGS

FIG. 1 illustrates a flowchart of a method for identifying a faulty processing unit, in accordance with one embodiment;

FIG. 2A illustrates a conceptual diagram of separate buffers written by each processing unit, in accordance with one embodiment;

FIG. 2B illustrates a conceptual diagram of a frame buffer with separate portions generated by each processing unit, in accordance with one embodiment;

FIG. 3 illustrates another conceptual diagram of separate buffers written by each processing unit when one processing unit was already disabled, in accordance with one embodiment;

FIG. 4 illustrates another flowchart of a method for identifying a faulty processing unit, in accordance with one embodiment;

FIG. 5 illustrates a parallel processing unit (PPU), according to one embodiment;

FIG. 6 illustrates the streaming multi-processor of FIG. 5, according to one embodiment; and

FIG. 7 illustrates an exemplary system in which the various architecture and/or functionality of the various previous embodiments may be implemented.

### DETAILED DESCRIPTION

An integrated circuit that fails to successfully pass chip-level testing may be functionally tested by executing a shader program to identify the particular processing unit that is faulty. Alternatively, an integrated circuit that passes chip-level testing may be tested to functionally verify the processing units within the integrated circuit and ensure that each processing unit functions properly. Identification of a faulty processing unit is possible because during execution, the shader program can access information that uniquely identifies the particular processing unit and encodes the information into the data generated by the particular processing unit. The shader program is executed in parallel by the processing units to save test time. The results are verified to identify which, if any, processing unit(s) are faulty. A faulty processing unit may be quickly identified. Once a faulty processing unit within an integrated circuit is identified, the individual faulty processing unit is disabled so that the integrated circuit can be salvaged as a lower performing part.

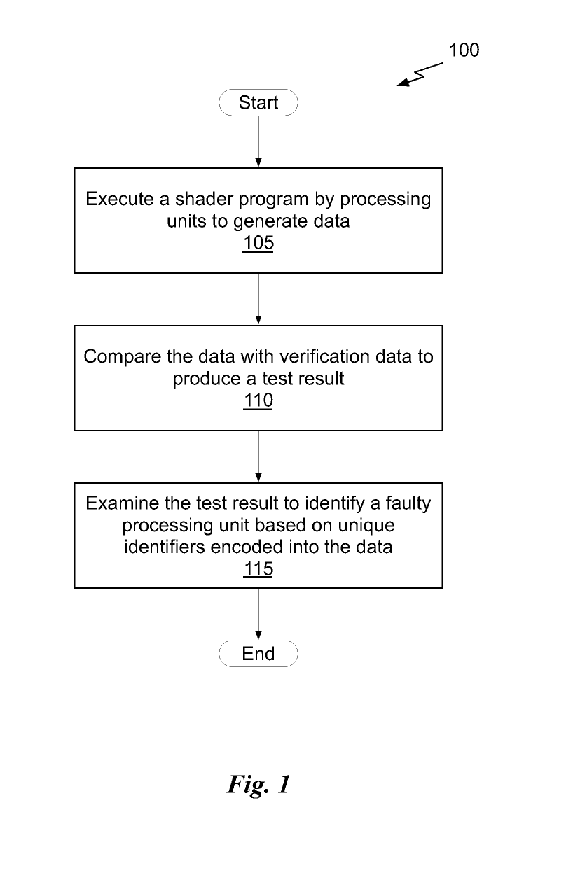

FIG. 1 illustrates a flowchart of a method 100 for identifying a faulty processing unit, in accordance with one embodiment. At step 105, a shader program that configures a processing unit to generate data is executed by two or more processing units. At step 110, the data is compared with verification data to produce a test result. At step 115, the test result is examined to identify a faulty processing unit of the two or more processing units based on a unique identifier corresponding to each processing unit that is encoded into the data generated by the respective processing unit. It should be noted that, while various optional features are set forth herein in connection with the shader program and processing unit, such features are set forth for illustrative purposes only and should not be construed as limiting in any manner.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

Conventional graphics processors that include multiple processing units are configured to execute shader programs. One technique for functionally verifying the multiple processing units is to execute a shader program and render an image. The pixels comprising the image can be examined and compared with the desired result to determine whether the multiple processing units are fully functional. Some conventional graphics processors that included multiple processing units can be configured such that each one of the multiple processing units generates the pixels for a particular portion of the image that is known in advance. For example, each processing unit of two processing units would generate pixels for either the right or left half or the top or the bottom half of the image. More complex screen partitioning can also be used to divide the image more finely between the different processing units and still meet the requirement that the portion of the image produced by each individual processing unit is known in advance. Specifically, when a conventional graphics processor is used to render an image, the processing unit that generated a particular pixel may be determined based on the screen coordinates of the pixel.

More recently, graphics processors have been developed that gain performance advantages by allowing any processing unit to contribute to the final value of any pixel. When these modern graphics processors are used to generate an image, and the generated image is not correct, it is not possible to determine which of the multiple processing units generated the incorrect data. In other words, there has not been a mechanism available for modern graphics processors by which to trace a particular pixel back to identify the processing unit that generated the pixel based on the screen coordinates of the pixel.

On newer graphics processors, a shader program is therefore configured to access a unique identifier that corresponds to the processing unit during execution of the shader program. The unique identifier is encoded into the data generated by the processing unit. Therefore, when a pixel is incorrect, the unique identifier may be used to trace the pixel back and identify the processing unit that generated the pixel. The unique identifier is independent of the pixel coordinates, so any of the processing units may generate any of the pixels of an image.

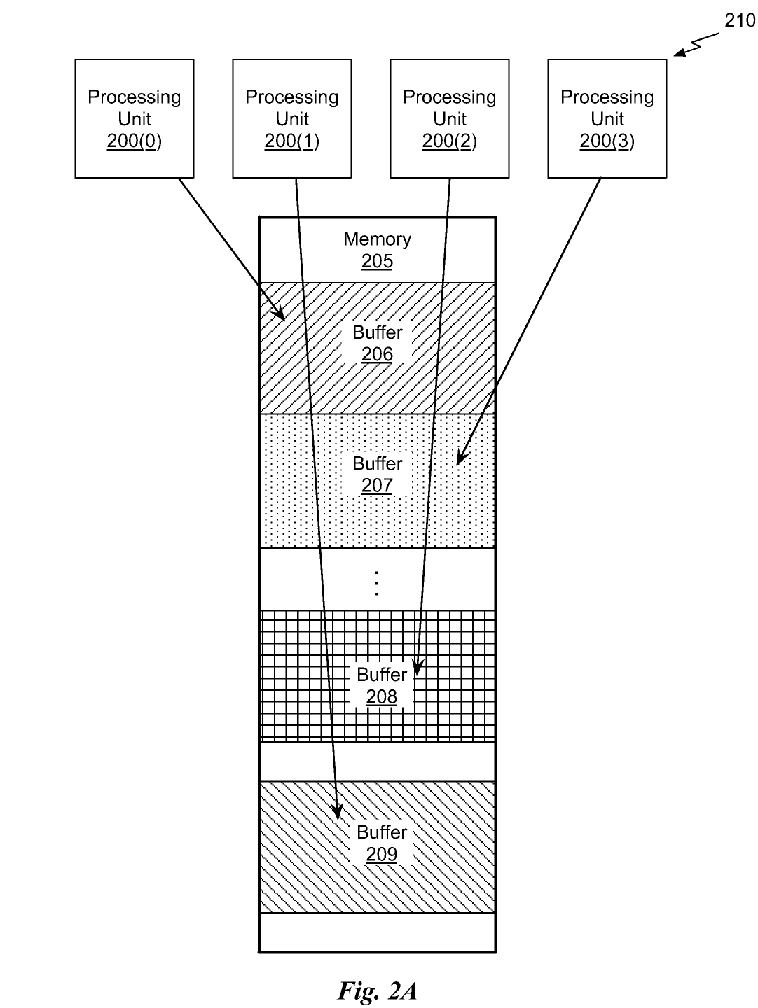

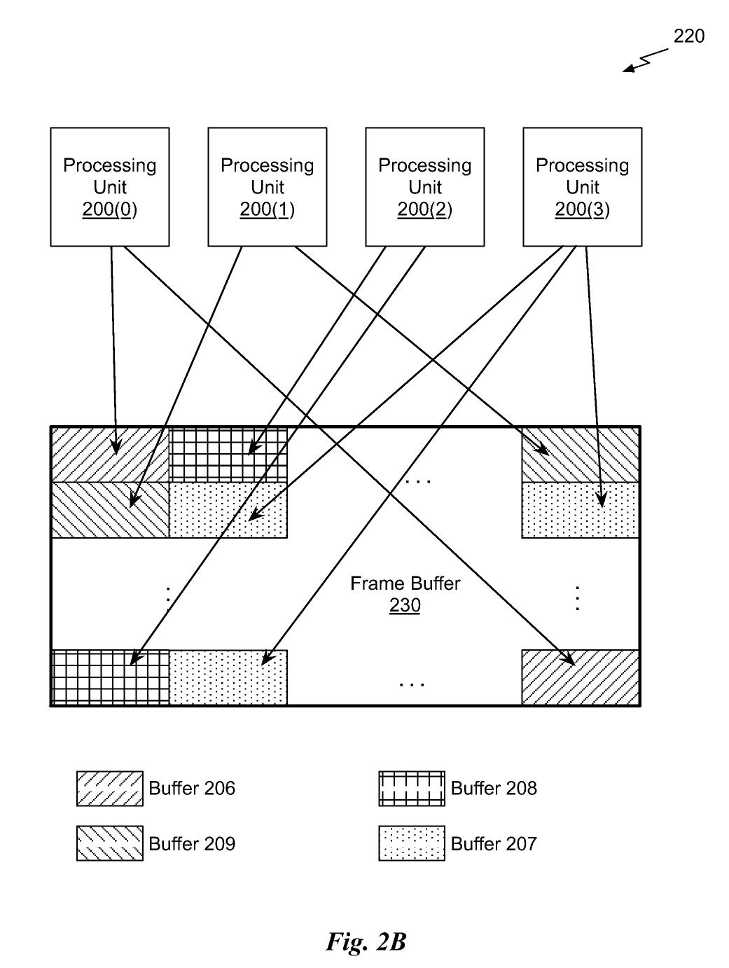

FIG. 2A illustrates a conceptual diagram 210 of separate buffers written by each processing unit 200, in accordance with one embodiment. As a shader program is executed by each of the processing units 200, a unique identifier obtained and encoded into the data that is generated. In one embodiment the unique identifier is a physical identifier corresponding to each respective processing unit 200 that is obtained using a read operation, For example, as shown in parentheses in FIG. 2A, the physical identifier for the leftmost processing unit 200 is 0. The physical identifier for the other processing units 200 are 1, 2, and 3 moving from left to right in FIG. 2A. A physical identifier may be stored in a read-only register or may be a hardwired value that is exposed through a read-only register. Typically, a particular physical identifier is associated with the same circuitry (i.e., physical instance of a particular processing unit 200) on all dies for the same integrated circuit. A logical identifier may also be assigned to each processing unit 240, and the logical identifiers may serve as unique identifiers. However, unlike the physical identifiers that cannot be reassigned to a different processing unit 200 after an integrated circuit has been fabricated, the logical identifiers may be reallocated by a software driver.

After the data is generated by a processing unit 200, the processing unit 200 executes instructions included in the shader program to conditionally write the data to one of several different buffers, depending on the unique identifier that is encoded into the data. As shown in FIG. 2A, four different buffers, buffers 206, 207, 208, and 209, are stored in a memory 205 and data generated by each of the processing units 200 is written to a different one of the four buffers 206, 207, 208, and 209, based on the unique identifiers. For example, data generated by the processing unit 200(0) is encoded with the unique identifier 0 and is conditionally written to the buffer 206 based on the unique identifier 0, Data generated by the processing unit 200(1) is encoded with the unique identifier 1 and is conditionally written to the buffer 207 based on the unique identifier 1, and so on. Assuming that shader program execution is deterministic, meaning that a particular pixel (or other data) will be generated by the same processing unit 200 each time the shader program is executed by the graphics processor, verification data may be generated in advance by executing the shader program on a known good graphics processor. More specifically, verification data may be precomputed for each one of the four buffers 206, 207, 208, and 209. While the same processing unit 200 will generate the same set of data, it is generally not possible to examine the shader program and identify which processing unit 200 will generate a particular set of data.

The unique identifiers are not necessarily written to the buffers 206, 207, 208, and 209 by the processing units 200. The contents of each of the buffers 206, 207, 208, and 209 are compared with verification data (i.e., correct data) to determine if any of the processing units 200 are faulty, In one embodiment, the verification data is a cyclic redundancy check (CRC) value. The graphics processor may be configured to compute CRC values for the contents of each one of the buffers 206, 207, 208, and 209. The computed CRC values may then be compared with the precomputed CRC values to determine if any of the processing units 200 are faulty. Any faulty processing units 200 that are identified as faulty may then be disabled. The unique identifier(s) corresponding to the faulty (if any) processing units 200 are reported by the software driver. Conventional techniques, such as blowing a fuse may be used to disable individual processing units 200.

The shader program that is executed by the processing units 200 may be a pixel shader, vertex shader, compute shader, or other type of shader program. When the shader program is a pixel shader program the data stored in the memory 205 represents pixels, where one of the components (e.g., color, intensity, luminance, alpha, or the like) of the pixel may be (or may contain) the unique identifier of the processing unit 200 that generated the data. When the shader program is a vertex shader program the data stored in the memory 205 is vertex data that represents vertex attributes, where one of the attributes may be the unique identifier of the processing unit 200 that generated the data. When the shader program is a compute shader program the data stored in the memory 205 represents outputs from the various compute threads. During execution of compute shaders, each thread can allocate memory to save the unique identifier of the processing unit that serviced that thread. A compute shader program may be written using the CUDA™ general purpose parallel computing platform and programming model.

FIG. 2B illustrates a conceptual diagram 220 of a frame buffer 230 with separate portions generated by each processing unit 200, in accordance with one embodiment. As previously explained, each processing unit 200 may contribute to the final value of any pixel. Therefore, data stored in the buffer 206 may map to any set of the pixels in the frame buffer 230. Similarly, data stored in the buffers 207, 208, and 209 may map to any set of the pixels in the frame buffer 230. The patterned blocks within the frame buffer 230 may each include one or more pixels.

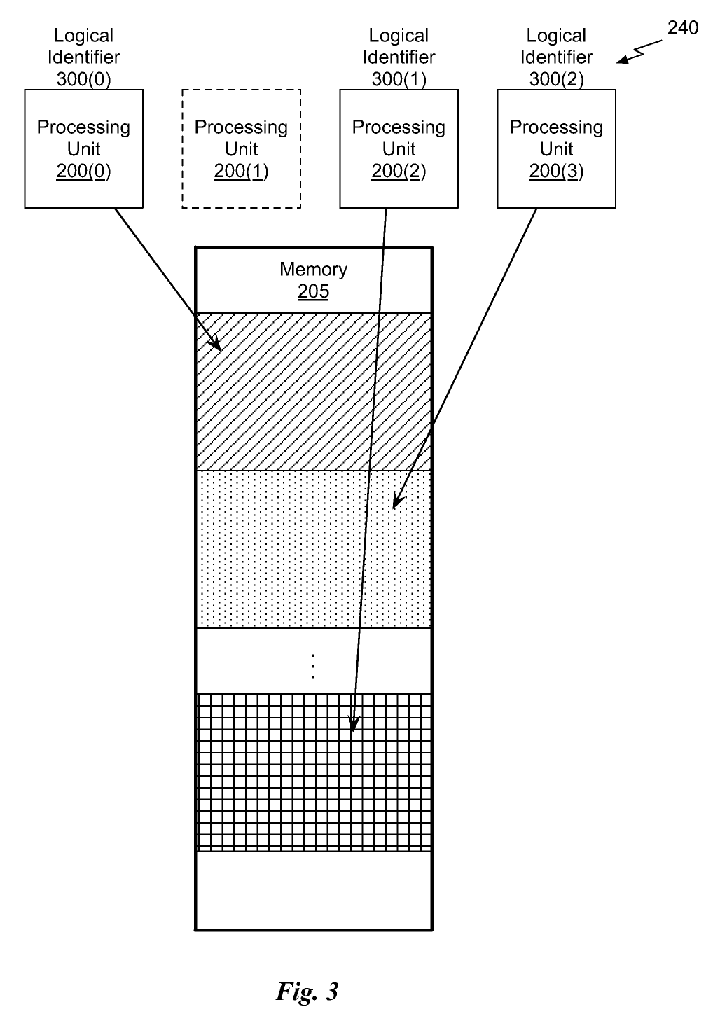

FIG. 3 illustrates another conceptual diagram 240 of separate buffers written by each processing unit 200 when one processing unit 200 is disabled, in accordance with one embodiment. A processing unit 200 may be disabled when the integrated circuit is tested at the chip level due to a failure that is detected when test patterns are applied at Automated Test Equipment (ATE) testing. As shown in FIG. 3, the processing unit 200(1) is disabled as a result of failing a chip level test. The enabled processing units 200(0), 200(2), and 200(3) each generate data that may represent an image. In one embodiment the portion of data that would have been generated by the processing unit 200(1) is generated by a combination of the enabled processing units 200(0), 200(2), and 200(3). The verification data may vary when one or more processing units 200 are disabled as a result of failing a chip level test. Therefore, different versions of the verification data should be precomputed by executing the shader program on a known good graphics processor, where each version corresponds to a possible configuration of enabled/disabled processing units 200.

In one embodiment, a logical identifier 300 is not assigned to the disabled processing unit 200(1). Therefore, the logical identifier 300 that is assigned to each processing unit 200 is not equal to the physical identifier corresponding to that processing unit 200. The software driver may be configured to map the logical identifiers 300 to the processing units 200 that are enabled. As shown in FIG. 3, the logical identifier 300(0) is mapped to the processing unit 200 having the physical identifier 0, the logical identifier 300(1) is mapped to the processing unit 200 having the physical identifier 2, and the logical identifier 300(2) is mapped to the processing unit 200 having the physical identifier 3. Even when none of the processing units 200 are disabled, the logical identifiers 300 may be mapped to the processing units 200 in a manner that does not result in the logical identifier 300 equaling the physical identifier for that processing unit 200.

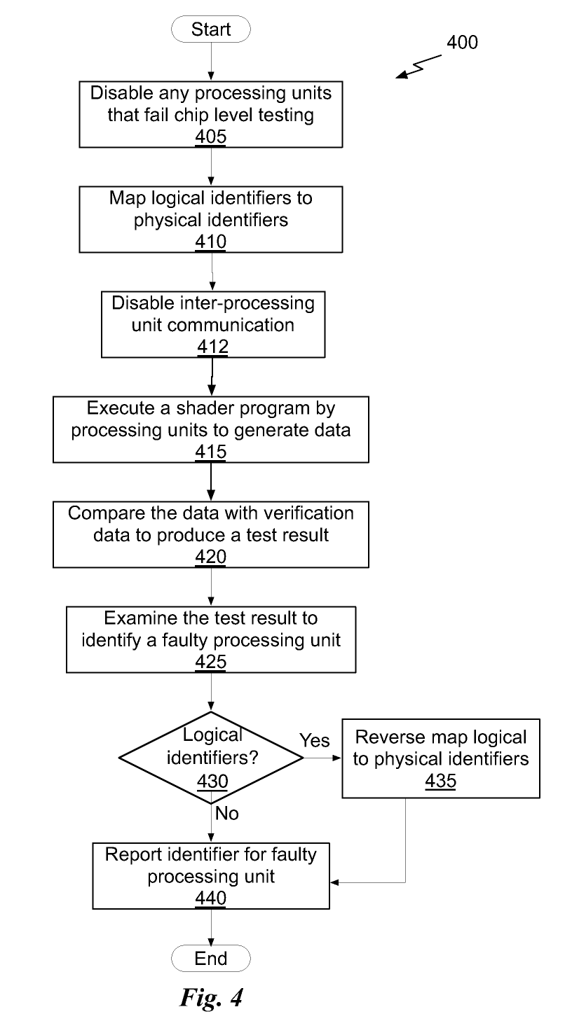

FIG. 4 illustrates another flowchart of a method 400 for identifying a faulty processing unit, in accordance with one embodiment. In one embodiment, the method is performed by a software driver. At step 405, any processing units 200 that fail chip level testing are disabled. The functional testing of the processing units 200 is then performed on the processing units 200 that passed the chip level testing and are enabled. At step 410, logical identifiers are mapped to physical identifiers, where each physical identifier corresponds to one of the processing units 200. At step 410, inter-processing unit 200 communication and inter-processing unit data dependence is disabled. For example, depth testing may be disabled for a pixel shader program to ensure that only one processing unit 200 can contribute to a value generated for a particular pixel.

At step 415, a shader program that configures a processing unit to generate data is executed by the enabled processing units 200. At step 420, the data is compared with corresponding verification data to produce a test result. In one embodiment, the comparison is performed by a test program executed by a general purpose processor, or other processor other than the graphics processor. At step 425, the test result is examined to identify a faulty processing unit 200 of the enabled processing units 200 based on a unique identifier corresponding to each processing unit that is encoded into the data generated by the respective processing unit 200.

At step 430, the software driver determines whether the unique identifiers that are encoded into the data are logical identifiers, and, if so, then, at step 435, a reverse mapping of logical identifiers to physical identifiers is performed to identify the faulty processing unit 200. Otherwise, the software driver proceeds directly to step 440. At step 440, the software driver reports the physical identifier for the faulty processing unit 200 so that the faulty processing unit 200 may be disabled.

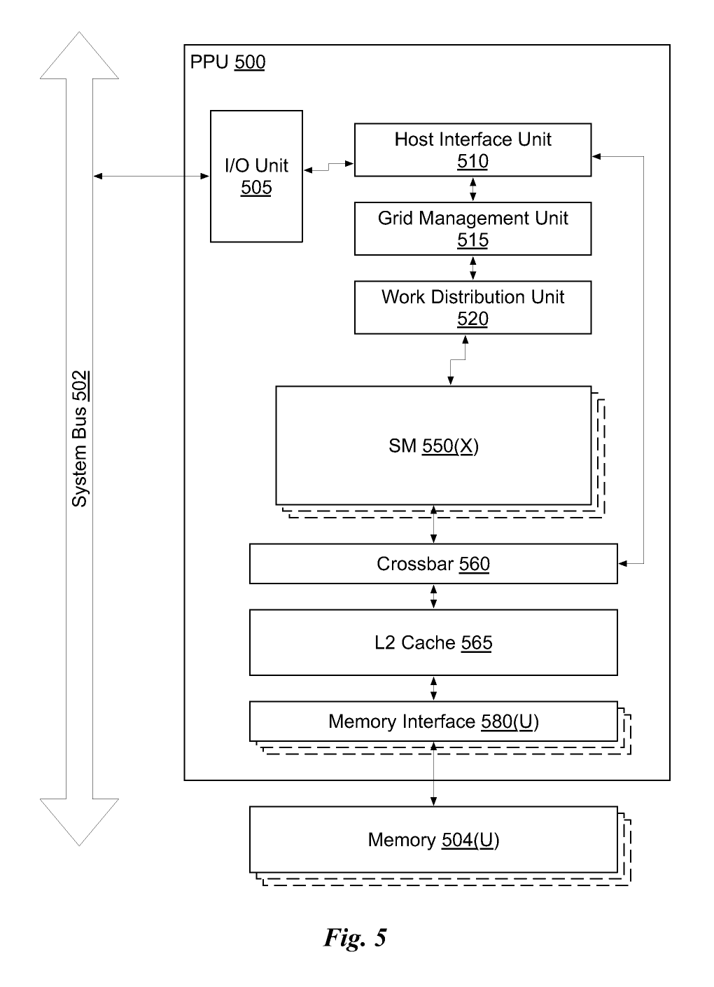

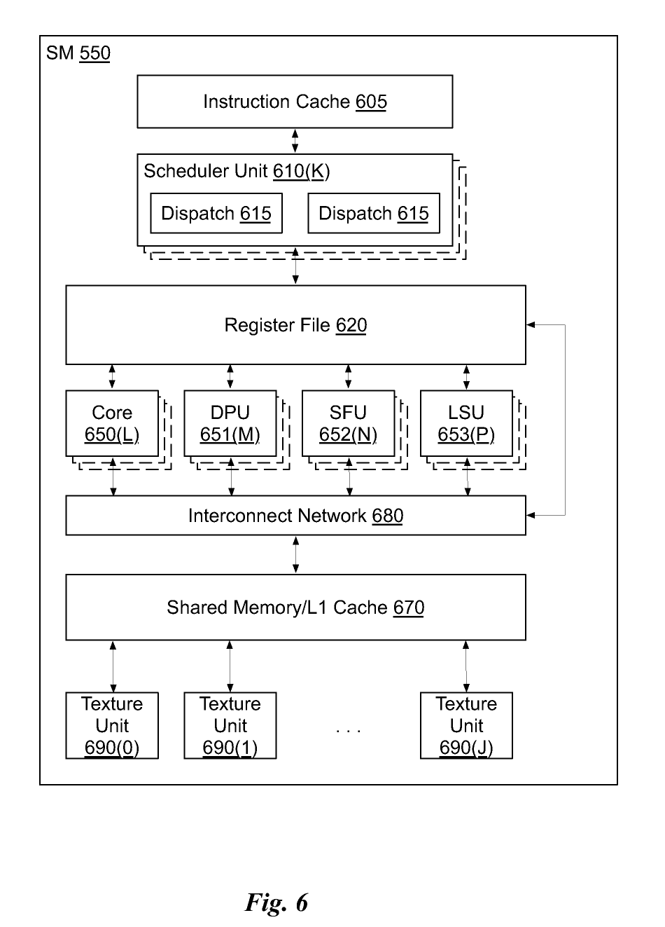

FIG. 5 illustrates a parallel processing unit (PPU) 500, according to one embodiment. While a parallel processor is provided herein as an example of the PPU 500, it should be strongly noted that such processor is set forth for illustrative purposes only, and any processor may be employed to supplement and/or substitute for the same. In one embodiment, the PPU 500 is configured to execute a plurality of threads concurrently in two or more streaming multi-processors (SMs) 550. A software driver may be configured to identify which, if any SMs 550 are faulty based on unique identifiers that are encoded in the data generated by the SMs 550. A thread (i.e. a thread of execution) is an instantiation of a set of instructions executing within a particular SM 550. Each SM 550, described below in more detail in conjunction with FIG. 6, may include, but is not limited to, one or more processing cores, one or more load/store units (LSUs), a level-one (L1) cache, shared memory, and the like.

In one embodiment, the PPU 500 includes an input/output (I/O) unit 505 configured to transmit and receive communications (i.e., commands, data, etc.) from a central processing unit (CPU) (not shown) over the system bus 502. The I/O unit 505 may implement a Peripheral Component Interconnect Express (PCIe) interface for communications over a PCIe bus. In alternative embodiments, the I/O unit 505 may implement other types of well-known bus interfaces.

The PPU 500 also includes a host interface unit 510 that decodes the commands and transmits the commands to the grid management unit 515 or other units of the PPU 500 (e.g., memory interface 580) as the commands may specify. The host interface unit 510 is configured to route communications between and among the various logical units of the PPU 500.

In one embodiment, a program encoded as a command stream is written to a buffer by the CPU. The buffer is a region in memory, e.g., memory 504 or system memory, that is accessible (i.e., read/write) by both the CPU and the PPU 500. The CPU writes the command stream to the buffer and then transmits a pointer to the start of the command stream to the PPU 500. The host interface unit 510 provides the grid management unit (GMU) 515 with pointers to one or more streams. The GMU 515 selects one or more streams and is configured to organize the selected streams as a pool of pending grids. The pool of pending grids may include new grids that have not yet been selected for execution and grids that have been partially executed and have been suspended.

A work distribution unit 520 that is coupled between the GMU 515 and the SMs 550 manages a pool of active grids, selecting and dispatching active grids for execution by the SMs 550. Pending grids are transferred to the active grid pool by the GMU 515 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 520. In addition to receiving grids from the host interface unit 510 and the work distribution unit 520, the GMU 510 also receives grids that are dynamically generated by the SMs 550 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 500. An application may include instructions (i.e., API calls) that cause the driver kernel to generate one or more grids for execution. In one embodiment, the PPU 500 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 500 comprises X SMs 550(X), For example, the PTV 100 may include 15 distinct SMs 550. Each SM 550 is multi-threaded and configured to execute a plurality of threads (e.g., 32 threads) from a particular thread block concurrently. Each of the SMs 550 is connected to a level-two (L2) cache 565 via a crossbar 560 (or other type of interconnect network). The L2 cache 565 is connected to one or more memory interfaces 580. Memory interfaces 580 implement 16, 32, 64, 128-bit data buses, or the like, for high-speed data transfer. In one embodiment, the PPD 500 comprises U memory interfaces 580(U), where each memory interface 580(U) is connected to a corresponding memory device 504(U). For example, PPU 500 may be connected to up to 6 memory devices 504, such as graphics double-data-rate, version 5, synchronous dynamic random access memory (GDDR5 SDRAM).

In one embodiment, the PPU 500 implements a multi-level memory hierarchy. The memory 504 is located off-chip in SDRAM coupled to the PPU 500. Data from the memory 504 may be fetched and stored in the L2 cache 565, which is located on-chip and is shared between the various SMs 550. In one embodiment, each of the SMs 550 also implements an L1 cache. The L1 cache is private memory that is dedicated to a particular SM 550. Each of the L1 caches is coupled to the shared L2 cache 565. Data from the L2 cache 565 may be fetched and stored in each of the L1 caches for processing in the functional units of the SMs 550.

In one embodiment, the PPU 500 comprises a graphics processing unit (GPU). The PPU 500 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 500 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (Le., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the GMU 515 may configure one or more SMs 550 to execute a vertex shader program that processes a number of vertices defined by the model data. In one embodiment, the GMU 515 may configure different SMs 550 to execute different shader programs concurrently. For example, a first subset of SMs 550 may be configured to execute a vertex shader program while a second subset of SMs 550 may be configured to execute a pixel shader program. The first subset of SMs 550 processes vertex data to produce processed vertex data and writes the processed vertex data to the L2 cache 565 and/or the memory 504. After the processed vertex data is rasterized (i.e., transformed from three-dimensional data into two-dimensional data in screen space) to produce fragment data, the second subset of SMs 550 executes a pixel shader to produce processed fragment data, which is then blended with other processed fragment data and written to the frame buffer in memory 504. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 500 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 500 is embodied on a simple semiconductor substrate. In another embodiment, the PPU 500 is included in a system-on-a-chip (SoC) along with one or more other :logic units such as a reduced instruction set computer (RISC) CPU, a memory management unit (MMU), a digital-to-analog converter (DAC), and the like.

In one embodiment, the PPU 500 may he included on a graphics card that includes one or more memory devices 504 such as GDDR5 SDRAM. The graphics card may be configured to interface with a PCIe slot on a motherboard of a desktop computer that includes, e.g., a northbridge chipset and a southbridge chipset. In yet another embodiment, the PPU 500 may he an integrated graphics processing unit (iGPU) included in the chipset (i.e., Northbridge) of the motherboard.

FIG. 6 illustrates the streaming multi-processor 550 of FIG. 5, according to one embodiment. As shown in FIG. 6, the SM 550 includes an instruction cache 605, one or more scheduler units 610, a register file 620, one or more processing cores 650, one or more double precision units (DPUs) 651, one or more special function units (SRN) 652, one or more load/store units (LSUs) 653, an interconnect network 680, a shared memory/L1 cache 670, and one or more texture units 690.

As described above, the work distribution unit 520 dispatches active grids for execution on one or more SMs 550 of the PPU 500. The scheduler unit 610 receives the grids from the work distribution unit 520 and manages instruction scheduling for one or more thread blocks of each active grid. The scheduler unit 610 schedules threads for execution in groups of parallel threads, where each group is called a warp. In one embodiment, each warp includes 32 threads. The scheduler unit 610 may manage a plurality of different thread blocks, allocating the thread blocks to warps for execution and then scheduling instructions from the plurality of different warps on the various functional units (i.e., cores 650, DPUs 651, SFUs 652, and LSUs 653) during each clock cycle.

In one embodiment, each scheduler unit 610 includes one or more instruction dispatch units 615. Each dispatch unit 615 is configured to transmit instructions to one or more of the functional units. In the embodiment shown in FIG. 6, the scheduler unit 610 includes two dispatch units 615 that enable two different instructions from the same warp to be dispatched during each clock cycle. In alternative embodiments, each scheduler unit 610 may include a single dispatch unit 615 or additional dispatch units 615.

Each SM 650 includes a register file 620 that provides a set of registers for the functional units of the SM 650. In one embodiment, the register file 620 is divided between each of the functional units such that each functional unit is allocated a dedicated portion of the register file 620. In another embodiment, the register file 620 is divided between the different warps being executed by the SM 550. The register file 620 provides temporary storage for operands connected to the data paths of the functional units.

Each SM 550 comprises L processing cores 650. In one embodiment, the SM 550 includes a large number (e.g., 192, etc.) of distinct processing cores 650. Each core 650 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 550 also comprises M DPUs 651 that implement double-precision floating point arithmetic, N SFUs 652 that perform special functions (e.g., copy rectangle, pixel blending operations, and the like), and P LSUs 653 that implement load and store operations between the shared memory/L1 cache 670 and the register file 620. In one embodiment, the SM 550 includes 64 DPUs 651, 32 SFUs 652, and 32 LSUs 653.

Each SM 550 includes an interconnect network 680 that connects each of the functional units to the register file 620 and the shared memory/L1 cache 670. In one embodiment, the interconnect network 680 is a crossbar that can be configured to connect any of the functional units to any of the registers in the register file 620 or the memory locations in shared memory/L1 cache 670.

In one embodiment, the SM 550 is implemented within a GPU. In such an embodiment, the SM 550 comprises J texture units 690. The texture units 690 are configured to load texture maps (i.e., a 2D array of texels) from the memory 504 and sample the texture maps to produce sampled texture values for use in shader programs. The texture units 690 implement texture operations such as anti-aliasing operations using mip-maps (i.e., texture maps of varying levels of detail). In one embodiment, the SM 550 includes 16 texture units 690.

The PPU 500 described above may be configured to perform highly parallel computations much faster than conventional CPUs. Parallel computing has advantages in graphics processing, data compression, biometrics, stream processing algorithms, and the like.

For example, a software driver may be configured to identify a faulty SM 550 by configuring the PPU 500 to execute a shader program. In one embodiment, the shader program generates data that is stored in separate buffers in the memory 504. The software driver may then read the separate buffers and compare the data to verification data to generate a test result. The test result indicates whether any of the data is incorrect. Based on a unique identifier that is encoded with the data, the software driver then identifies the SM 550 that generated the incorrect data and may disable the SM 550.

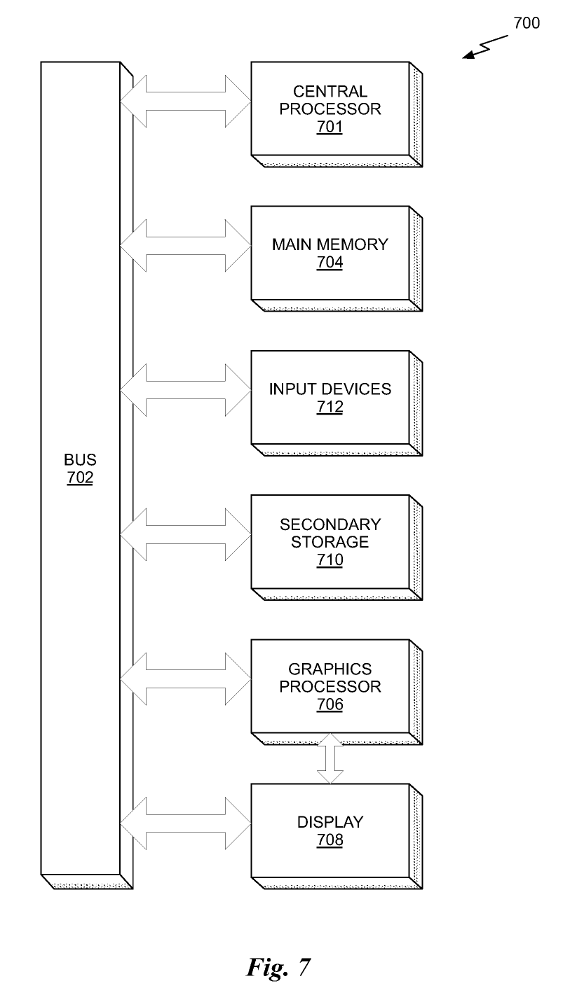

FIG. 7 illustrates an exemplary system 700 in which the various architecture and/or functionality of the various previous embodiments may be implemented. As shown, a system 700 is provided including at least one central processor 701 that is connected to a communication bus 702. The communication bus 702 may be implemented using any suitable protocol, such as PCI (Peripheral Component Interconnect), PCI-Express, AGP (Accelerated Graphics Port), HyperTransport, or any other bus or point-to-point communication protocol(s). The system 700 also includes a main memory 704. Control logic (software) and data are stored in the main memory 704 which may take the form of random access memory (RAM).

The system 700 also includes input devices 712, a graphics processor 706, and a display 708, i.e, a conventional CRT (cathode ray tube), LCD (liquid crystal display), LED (light emitting diode), plasma display or the like. User input may be received from the input devices 712, e.g., keyboard, mouse, touchpad, microphone, and the like. In one embodiment, the graphics processor 706 may include a plurality of shader modules, a rasterization module, etc. Each of the foregoing modules may even be situated on a single semiconductor platform to form a graphics processing unit (CPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710, The secondary storage 910 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 704 and/or the secondary storage 710. Such computer programs, when executed, enable the system 700 to perform various functions. The memory 704, the storage 710, and/or any other storage are possible examples of computer-readable media.

In one embodiment, the architecture and/or functionality of the various previous figures may be implemented in the context of the central processor 701, the graphics processor 706, an integrated circuit (not shown) that is capable of at least a portion of the capabilities of both the central processor 701 and the graphics processor 706, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, laptop computer, server, workstation, game consoles, embedded system, and/or any other type of logic. Still yet, the system 700 may take the form of various other devices including, but not limited to a personal digital assistant (PDA) device, a mobile phone device, a television, etc.

Further, while not shown, the system 700 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
executing a shader program that configures a plurality of processing units to generate data;
comparing the data with verification data to produce a test result; and
examining the test result to identify a faulty processing unit of the plurality of processing units, wherein a unique identifier corresponding to each processing unit is encoded into the data generated by the respective processing unit.

2. The method of claim 1, wherein the unique identifier is a logical identifier.

3. The method of claim 2, further comprising mapping the logical identifier to a physical identifier.

4. The method of claim 1, further comprising, prior to executing the shader program, disabling an additional processing unit.

5. The method of claim 1, wherein a first unique identifier corresponding to a disabled processing unit of the plurality of processing units is mapped to a first enabled processing unit of the plurality of processing units.

6. The method of claim 1, wherein the unique identifier for each processing unit is obtained by a read operation during execution of the shader program.

7. The method of claim 1, wherein the unique identifier is a physical identifier.

8. The method of claim 1, wherein the shader program further configures each one of the processing units to write a portion of the data to a separate buffer based on the unique identifiers.

9. The method of claim 1, wherein the shader program is a pixel shader program and the data is pixel data.

10. The method of claim 1, wherein the shader program is a vertex shader program and the data is vertex data.

11. The method of claim 1, wherein the shader program is a compute shader program.

12. The method of claim 1, further comprising, prior to executing the shader program, disabling inter-processing unit communication and inter-processing unit data dependence.

13. A non-transitory computer-readable storage medium storing instructions that, when executed by a processor, cause the processor to perform steps comprising:
executing a shader program that configures a plurality of processing units to generate data;
comparing the data with verification data to produce a test result; and
examining the test result to identify a faulty processing unit of the plurality of processing units, wherein a unique identifier corresponding to each processing unit is encoded into the data generated by the respective processing unit.

14. The non-transitory computer-readable storage medium of claim 13, wherein the shader program further configures each one of the processing units to write a portion of the data to a separate buffer based on the unique identifiers.

15. The non-transitory computer-readable storage medium of claim 13, wherein the unique identifier for each processing unit is obtained by a read operation during execution of the shader program.

16. The non-transitory computer-readable storage medium of clam 13, wherein the unique identifier is a physical identifier.

17. The non-transitory computer-readable storage medium of claim 13, wherein the shader program is a pixel shader program and the data is pixel data.

18. A system comprising:
a memory storing a shader program;
a plurality of processing units coupled to the memory and configured to execute the shader program to generate data;
a processor coupled to the memory and configured to:
compare the data with verification data to produce a test result; and
examine the test result to identify a faulty processing unit of the plurality of processing units, wherein a unique identifier corresponding to each processing unit is encoded into the data generated by the respective processing unit.

19. The system of claim 18, wherein the plurality of processing units reside within a graphics processing unit.

20. The system of claim 18, wherein the processor is further configured to disable the faulty processing unit.
